(19) United States
(12) Patent Application Publication
(10) Pub. No.: US 2016/0110479 A1
(43) Pub. Date: Apr. 21, 2016

(54) SYSTEM AND METHOD FOR CONSTRUCTING CUSTOMIZED FOOT ORTHOTICS

(71) Applicant: Yong Li, LaSalle (CA)

(72) Inventor: Yong Li, LaSalle (CA)

(21) Appl. No.: 14/638,911

(22) Filed: Mar. 4, 2015

Related U.S. Application Data
(60) Provisional application No. 62/064,285, filed on Oct. 15, 2014.

(51) Int. Cl. G06F 17/50; G06F 3/0484

(52) U.S. Cl. CPC G06F 17/50; G06F 3/0484

(57) ABSTRACT

A method of constructing a customized foot orthotic model comprises receiving a model for a contoured surface of a foot device, the model corresponding to a plantar surface of a foot. The model includes data representing three-dimensional coordinates of discrete points on the contoured surface. Coordinates of selected discrete points along selected longitudinal and transverse lines on the contoured surface are obtained, and the vertical coordinates of points are adjusted based on received orthotic parameters for a customized orthotic device. A foot orthotic model is constructed, comprising data representing an orthotic surface. The orthotic surface is constructed based on the points with adjusted coordinates, and the foot orthotic model is provided to a fabrication facility for automated fabrication of the foot orthotic device.

### RELATED APPLICATIONS

This application claims the benefit of, and priority from, U.S. Provisional Patent Application No. 62/064,285, filed Oct. 15, 2014, the entire contents of which are incorporated herein by reference.

### FIELD

The present invention relates to orthotic devices, in particular, methods and systems for constructing custom foot orthotic models and devices.

### BACKGROUND

The feet are the foundation and base of support for the entire body, whether standing walking or running. Weakness, instability or lack of shock absorption in the feet can contribute to postural and stress problems throughout the rest of the body which can lead to knee, hip and back and even shoulder and neck pain. Foot orthotics is a specially designed medical device that is worn inside a shoe to control abnormal foot function or accommodate painful areas of the foot. Properly designed foot orthotics may compensate for impaired foot function, by controlling abnormal motion across the joints of the foot.

To provide the desired fit and function, orthotic devices may be customized to have specific characteristics such as shape and stiffness. Traditionally, designing and fabricating custom orthotics is a multi-step process. First, a practitioner such as a podiatrist starts with a plaster or foam box cast or a 3D scan of a foot and, after an examination of foot symptoms, writes a prescription for a corrective orthotic device. The cast and prescription are then sent to an orthotic lab with extensive computer aided design (CAD)/computer aided manufacturing (CAM) capabilities. Typically, the orthotic lab generates foot positive molds from negative molds such as foot casts and then custom foot orthotics are manually fabricated by using the foot positive molds. Custom foot orthotics are currently mainly fabricated manually based on craftsmen's skill and experience and require substantial time to complete. Some orthotic labs use general-purpose CAD/CAM software to aid this fabrication process, which is relatively flexible, but requires a trained operator with experience, is time consuming to use and prone to human error. In addition, a prescribing practitioner can only see a foot orthotic device after it has been physically fabricated. The practitioner usually has no opportunity to preview or modify foot orthotics during the fabrication process.

### SUMMARY

In an aspect of the present disclosure, a method of constructing a customized foot orthotic model for a foot comprises: receiving an initial model for a contoured surface of a foot device that fits a plantar surface of a specific foot, the initial model comprising data representing three-dimensional coordinates of a plurality of discrete points on the contoured surface; receiving a plurality of orthotic parameters for constructing a foot orthotic device customized for the specific foot; electronically obtaining coordinates of selected ones of the discrete points distributed along selected longitudinal and transverse lines on the contoured surface, and electronically adjusting vertical coordinates of the selected points based on a first subset of the orthotic parameters; electronically constructing a foot orthotic model comprising data representing an orthotic surface of the foot orthotic device, the orthotic surface constructed based on the selected points with adjusted coordinates; and providing the foot orthotic model to a fabrication facility for automated fabrication of the foot orthotic device based on the foot orthotic model. The selected lines may comprise three longitudinal lines and three transverse lines. The method may comprise determining a reference plane, a longitudinal axis, and a transverse axis for the contoured surface, wherein the reference plane is parallel to the longitudinal axis and the transverse axis and is perpendicular to a vertical axis for the contoured surface; and re-registering the plurality of discrete points in a coordinate system such that each one of the longitudinal lines is in a corresponding plane parallel to the longitudinal axis and the vertical axis, and each one of the transverse lines is in a corresponding plane parallel to the transverse axis and the vertical axis. Each line may be determined using a spline function and control points distributed along the corresponding plane. The method may also comprise partitioning the contour surface into a heel section and a forefoot section, wherein the reference plane is defined by a bottom point in the heel section, a lateral bottom point in the forefoot section, and a medial bottom point in the forefoot section. The orthotic parameters may comprise an arch shape parameter, a heel cup depth parameter, a forefoot width parameter or a heel width parameter; and vertical coordinates of the selected points in the arch section may be adjusted based on the arch shape parameter, the heel section may be trimmed or extended based on the heel cup depth parameter, or the forefoot section or the heel section may be narrowed or widened based on the forefoot width parameter or the heel width parameter. The constructing may comprise electronically generating additional surface points for the orthotic surface by extrapolation based on the selected points. The foot orthotic model may further comprise data representing a bottom surface opposite to the orthotic surface, the bottom surface constructed based on a pre-defined surface and a second subset of the orthotic parameters. The orthotic parameters may comprise a posting parameter, and the bottom surface is tilted, or includes a posting for raising the heel or forefoot section based on the posting parameter.

In another aspect of the present disclosure, a computing device comprises: a processor; an input/output device in communication with the processor; a memory in communication with the processor; and processor-executable code stored in the memory, which, when executed by the processor, causes the computing device to: receive, over the input/output device, a first data structure comprising an initial model for a contoured surface of a foot device that fits a plantar surface of a specific foot, the initial model comprising data representing three-dimensional coordinates of a plurality of discrete points on the contoured surface; receive, over the input/output device, a second data structure comprising a plurality of orthotic parameters for constructing a foot orthotic device customized for the specific foot; obtain coordinates of selected ones of the discrete points distributed along selected longitudinal and transverse lines on the contoured surface, and adjust vertical coordinates of the selected points based on a first subset of the orthotic parameters; construct a foot orthotic model comprising data representing an orthotic surface of the foot orthotic device, the orthotic surface constructed based on the selected points with adjusted coordinates; and provide the foot orthotic model to a fabrication facility over the input/output device for automated fabrication of the foot orthotic device based on the foot orthotic model. The selected lines may comprise three longitudinal lines and three transverse lines. The code may cause the computing device to: determine a reference plane, a longitudinal axis, and a transverse axis for the contoured surface, wherein the reference plane is parallel to the longitudinal axis and the transverse axis and is perpendicular to a vertical axis for the contoured surface; and re-register the plurality of discrete points in a coordinate system such that each one of the longitudinal lines is in a corresponding plane parallel to the longitudinal axis and the vertical axis, and each one of the transverse lines is in a corresponding plane parallel to the transverse axis and the vertical axis. Each line may be determined using a spline function and control points distributed along the corresponding plane. The code may cause the computing device to partition the contour surface into a heel section and a forefoot section, and the reference plane may be defined by a bottom point in the heel section, a lateral bottom point in the forefoot section, and a medial bottom point in the forefoot section. The orthotic parameters may comprise an arch shape parameter, a heel cup depth parameter, a forefoot width parameter or a heel width parameter; and vertical coordinates of the selected points in the arch section may be adjusted based on the arch shape parameter, the heel section may be trimmed or extended based on the heel cup depth parameter, or the forefoot section or the heel section may be narrowed or widened based on the forefoot width parameter or the heel width parameter. The code may cause the computing device to generate additional surface points for the orthotic surface by extrapolation based on the selected points. The foot orthotic model may further comprise data representing a bottom surface opposite to the orthotic surface, the bottom surface constructed based on a pre-defined surface and a second subset of the orthotic parameters. The orthotic parameters may comprise a posting parameter, and the bottom surface may be tilted, or may include a posting for raising the heel or forefoot section based on the posting parameter. The computing device may be in communication with a scanning device for providing the first data structure and with a user interface device for providing the second data structure, and the fabrication facility may comprise an additive manufacturing device for fabricating the foot orthotic device.

In a further aspect of the present disclosure, a computing device for constructing customized foot orthotics comprises: an input module for receiving a first data structure comprising three-dimensional coordinates of discrete points on a plantar surface of a scanned foot and a second data structure comprising a plurality of orthotic parameters for constructing foot orthotics customized for the scanned foot; a contour constructing module configured to determine contour points distributed along selected longitudinal and transverse lines on the plantar surface, and to adjust coordinates of the contour points based on a first subset of the orthotic parameters; a model constructing module configured to construct an orthotic surface based on the contour points with adjusted coordinates, and to construct a orthotic model based the orthotic surface; and an output module for communicating with a fabrication device to produce customized foot orthotics from the orthotic model.

### BRIEF DESCRIPTION OF THE DRAWINGS

In the figures, which illustrate by way of example only, embodiments of this invention:

FIG. 1 is a schematic block diagram of a manufacturing system operable to design and fabricate custom foot orthotics;

FIG. 2 is a schematic block diagram of a computing device of the system of FIG. 1;

FIG. 3 is a block diagram of application software components at the computing device of FIG. 2;

FIG. 4A is a representation of a point cloud produced by a scanning device of the system of FIG. 1;

FIG. 4B is a data structure storing coordinates of the point cloud of FIG. 4A;

FIG. 5 is a schematic diagram illustrating a user interface at the computing device of FIG. 2;

FIG. 6A is a schematic diagram of a data structure created from data input in the user interface of FIG. 5;

FIG. 6B is a set of example values of the data structure of FIG. 6A;

FIG. 7 is a schematic block diagram of the server of the system of FIG. 1;

FIG. 8 is a block diagram of application software components at the server of FIG. 7;

FIG. 9 is a flow chart of a process for constructing customized foot orthotics;

FIG. 10 is a flow chart of a sub-process of the process of FIG. 9;

FIG. 11A is a representation of a lateral view of the point cloud of FIG. 4A;

FIG. 11B is a topographic map of the bottom view of the point cloud of FIG. 4A;

FIG. 12 is a schematic diagram depicting a data structure based on the data structure of FIG. 4B;

FIG. 13 is a representation of a bottom view of the point cloud of FIG. 4A;

FIG. 14 is a representation of the point cloud of FIG. 4A in perspective view, showing curved lines connecting selected points of anatomical interest;

FIG. 15A is a representation of surface contours constructed from the curved lines of FIG. 4A and modifications to the surface contours;

FIGS. 15B-15E are detailed representations of modifications to surface contours of FIG. 15A;

FIG. 16 is a representation of a surface constructed from the contours of FIG. 15;

FIG. 17 is a representation of a first stage of construction of an orthotic model from the surface of FIG. 16, in perspective view;

FIG. 18 is a representation of a second stage of construction of the orthotic model, in perspective view;

FIG. 19 is a flow chart of a sub-process of the process of FIG. 9;

FIG. 20 is a representation of the orthotic model of FIG. 18 in perspective view, with an added stiffening structure in a first stage of construction;

FIG. 21 is a representation of the orthotic model of FIG. 18 in perspective view, with an added stiffening structure in a second stage of construction;

FIG. 22 is a representation of the orthotic model of FIG. 18 in perspective view, with an added stiffening structure in a third stage of construction;

FIG. 23 is a perspective view of a custom orthotic device at a first stage of fabrication; and

FIG. 24 is a perspective view of a custom orthotic device at a second stage of fabrication.

### DETAILED DESCRIPTION

As used in this specification and the appended claims, the technical and scientific terms used in the descriptions herein will have the meanings commonly understood by one of ordinary skill in the art, unless specifically defined otherwise.

“Foot orthotic devices” refer to specially designed medical devices or inserts that are worn inside the shoe. Foot orthotic devices may modify or assist foot function. The term “foot orthotics” may be used to refer to foot orthotic devices or electronic models of such devices. As is known in the art, orthotics is concerned with design, manufacture and application of orthoses, which are externally applied devices used to modify structural and functional characteristics of the neuromuscular and skeletal system. For example, foot orthotics may be designed to support specific areas of a foot, to address abnormal foot function or anatomy, or to ameliorate foot pain or other symptoms.

“Top surface” of a foot orthotics refers to the top surface that faces the sole (or plantar surface) of a user's foot when the foot orthotics is worn by the user. “Bottom surface” of the foot orthotics refers to the bottom surface that faces the shoe-bed surface when the foot orthotics is worn by the user. The distance between the top and bottom surfaces of the foot orthotics is referred to as the “thickness” of the foot orthotics.

“Forefoot” refers to the five toes and five metatarsal bones. “Midfoot” refers to the bones of navicular, cuboid, and the three cuneiforms. They form the arch of the foot which serves as a shock absorber. “Rearfoot” is composed of the talus (or ankle bone) and the calcaneus (or heel bone). “Medial arch” refers to the longitudinal arch made up by the calcaneus, the talus, the navicular, the three cuneiforms, and the first, second, and third metatarsals. “Lateral arch” refers to the longitudinal arch made up by the calcaneus, the cuboid, and the fourth and fifth metatarsals. The medial arch is normally higher than the lateral arch.

“Additive manufacturing technology” refers to various processes for making a three-dimensional (3D) object from a 3D model or other electronic data source primarily through additive processes in which successive layers of material are laid down under computer control. The processes include, but not limited to, fused deposition modelling (FDM), stereolithography (SLA), laminated object manufacturing (LOM), electron beam melting (EBM), selective laser sintering (SLS) and inkjet material deposition (IMD). Additive manufacturing technologies may also be known as “3D printing” and additive manufacturing devices may be referred to as “3D printers”.

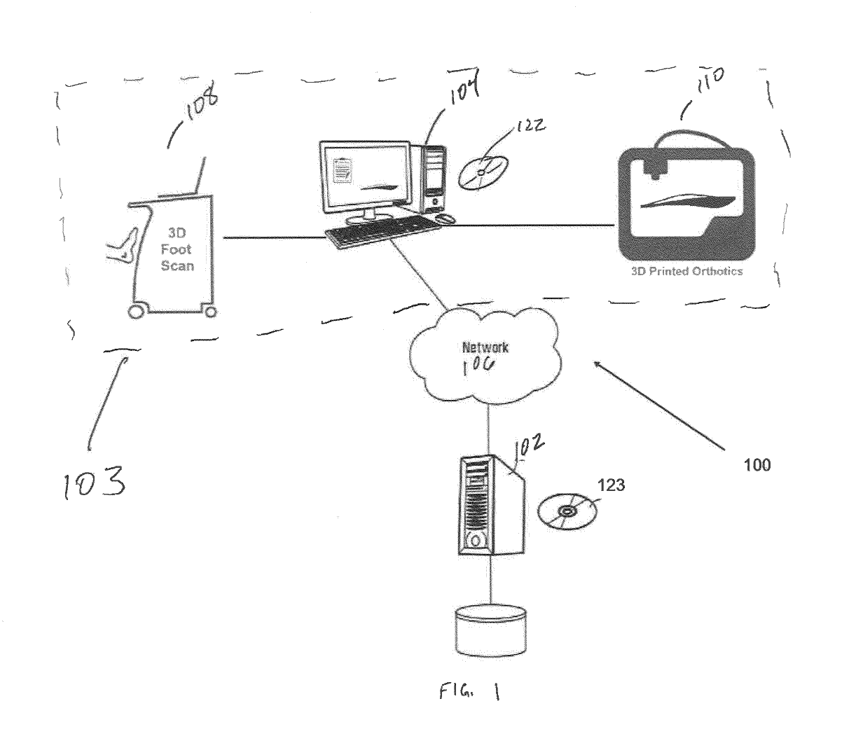

FIG. 1 depicts an example orthotics manufacturing system 100 for designing and fabricating custom foot orthotics. Orthotics manufacturing system 100 includes a server 102 and at least one fabrication facility 103. Fabrication facility includes a computing device 104 connected to a scanning device 108 and a printing device 110. Server 102 and computing device 104 are connected to a computer network 106. Computer network 106 may be a wide-area network such as the internet, or may be a private or local area network, and may include wired or wireless access points.

Computing device 104 may be a PC running a Microsoft Windows operating system or other suitable operating system such as Linux or OSX.

Scanning device 108 is connected to computing device 104, for example, by universal serial bus (USB) or over a network connection such as a wireless local area network (WLAN) connection or Ethernet, and is operable to measure the surface of a patient's foot and return to computing device 104 three-dimensional coordinates of points on the surface. Scanning device 108 may for example be a 3D laser scanner such as a ShapeGrabber SG502, structured light scanner such as a GOM ATOS Core 300 or photogrammetry device such as a PhotoModeler, produced by EOS Systems.

Printing device 110 is connected to computing device 104, for example, by USB or over a network connection such as WLAN or Ethernet, and is operable to receive instructions from computing device 104 and fabricate foot orthotics in accordance with a model at computing device 104. Printing device 110 may for example be a three-dimensional printer such as a Makerbot Replicator, produced by MakerBot Industries LLC. Printing device 110 may be capable of printing custom orthotic devices from feedstocks including, but not limited to nylon, polyester, nylon-polyester blend, polyethylene, polypropylene, acrylonitrile butadiene styrene, polylactic acid, polycarbonate, rubber, foam rubber, ethylene vinyl acetate, fiberglass, or carbon fiber graphite.

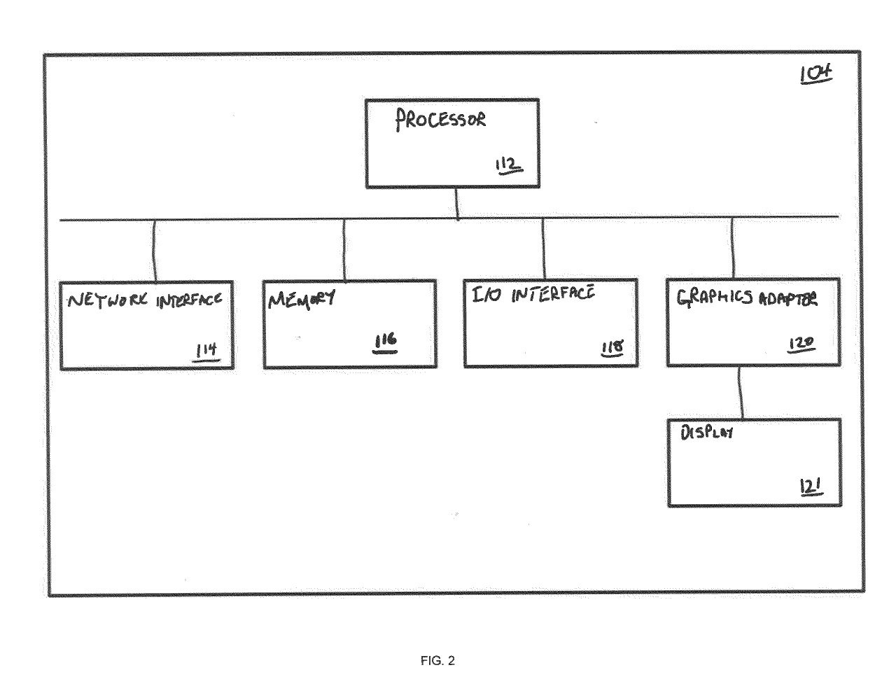

FIG. 2 depicts components of computing device 104 in greater detail. Computing device 104 includes a processor 112, a network interface 114, a memory 116, at least one I/O interface 118, such as a USB controller or the like, and a graphics adapter 120 for controlling an interconnected display 121. Processor 112 may be an Intel x86, PowerPC, ARM processor or the like. Network interface 114 may, for example, be an Ethernet or WLAN adapter or cellular modem. Network interface 114 interconnects computing device 104 to network 106 to send and receive data. Memory 116 may be organized using a filesystem configured to store data structures as will be described in greater detail below.

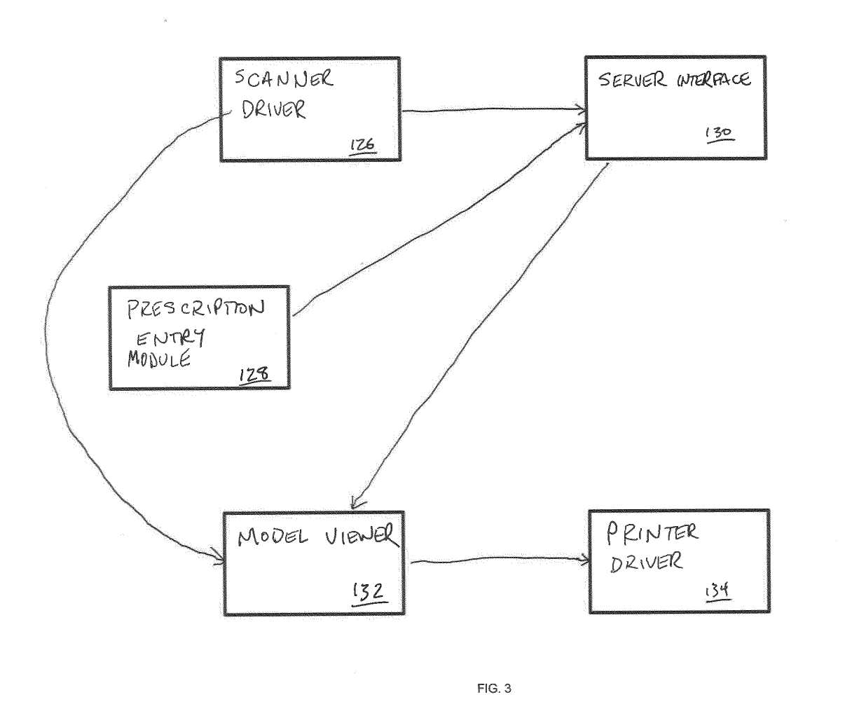

Computing device 104 executes application software loaded from a computer-readable medium 122 (FIG. 1). As will be apparent, software may be loaded from a computer-readable medium local to computing device 104, or may be from a computer-readable medium by way of a network connection. Loaded application software may be stored in memory 116 and subsequently accessed from memory 116. FIG. 3 depicts components of application software at computing device 104. Application software at computing device 104 may include a scanner driver 126, a prescription entry module 128, a server interface module 130, a model viewer 132, and a printer driver 134.

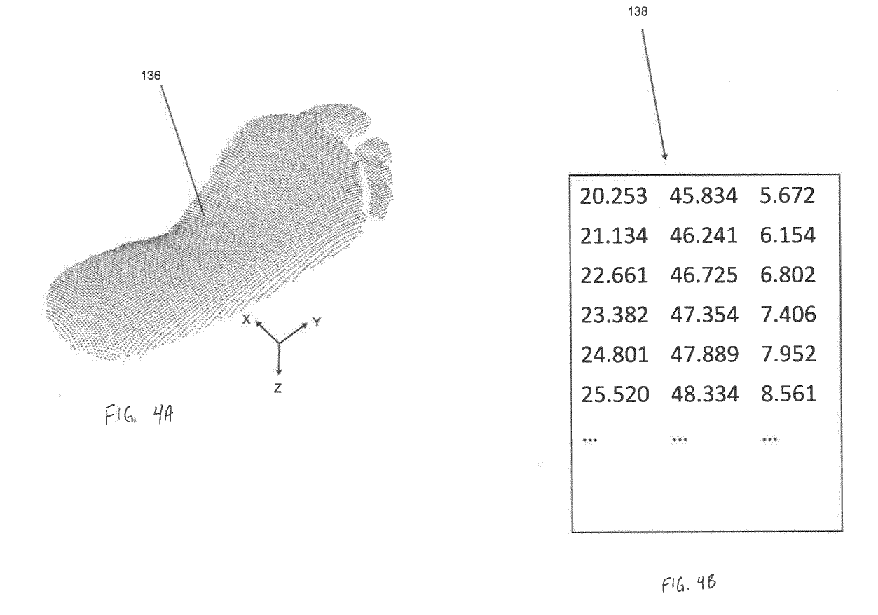

Scanner driver 126 interfaces with scanning device 108 by way of network interface 114 or I/O interface 118 to send instructions to and receive data from scanning device 108. Specifically, scanner driver 126 can be invoked from computing device 104 to send instructions causing scanning device 108 to scan a foot and return data containing a point cloud 136 for the sole surface of the scanned foot (FIG. 4A), comprising a set of three-dimensional coordinates of points on at least the plantar surface of the foot. Scanner driver 126 forms a data structure 138 from the point cloud 136 so that it can be stored in memory 116 for later access from computing device 104. Data structure 138 may, for example, be a delimited text file as shown in FIG. 4B, with delimited X, Y and Z coordinates for each point in point cloud 136. The coordinate values are relative to a coordinate system assigned by scanning device 110 and thus the X, Y and Z values may not align with the frontal, longitudinal and transverse axes of the patient's body. Data structure 138 may alternatively be a table, an array or other suitable structure. Scanner driver 126 is configured to output data structure 138 to server interface 130 for provision to server 102 over network interface 114.

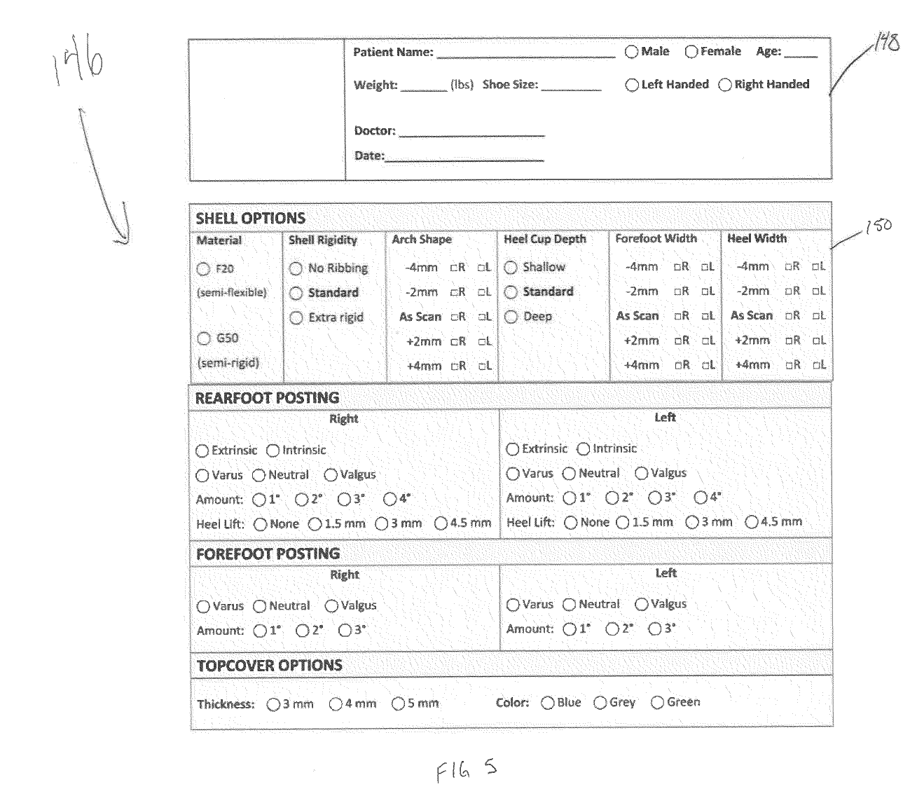

Prescription entry module 128 is configured to provide instructions to cause graphics adapter 120 to present a user interface on display 121 to receive input parameters for foot orthotics for the scanned foot. An example user interface 146 is shown in FIG. 5.

User interface 146 has an information block 148 with entry fields for properties such as patient name, sex, age, weight, shoe size, left/right handedness, doctor name and date.

User interface 146 further has a parameter entry block 150 for receiving input parameters defining orthotic characteristics of the foot orthotics to be constructed (hereinafter, “orthotic parameters”). Parameters input to property entry block 150 may include, for example, material type; rigidity; arch shape; heel cup depth (which may be selected from among discrete depth levels or entered as a numerical adjustment value); forefoot width; heel width; rearfoot posting type (extrinsic or intrinsic); rearfoot posting direction (varus, neutral or valgus); heel lift; forefoot posting direction (varus, neutral or valgus); forefoot posting amount; top cover thickness and top cover color. As will be appreciated, some or all of the input parameters may vary between a matched pair of right foot and left foot orthotics. For example, a prescription may call for 2 mm of heel lift for a patient's right foot and 4 mm of heel lift for a patient's left foot. Prescription entry block 150 may be arranged to simultaneously receive input parameters for a matching right foot and left foot pair, and may allow for values of the parameters to vary between feet.

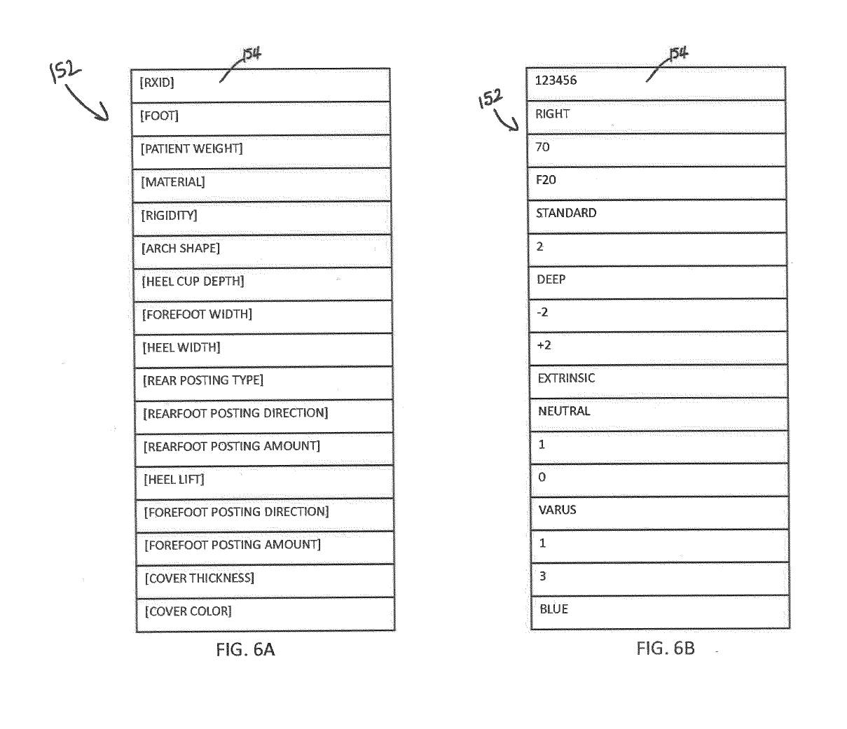

Prescription entry module 128 constructs a data structure 152 for storage in memory 116. FIG. 6A shows an example data structure 152 and FIG. 6B shows an example set of values of data structure 152. Data structure 152 is an array of values comprising a field for each parameter in prescription entry block 150. In addition, data structure may comprise one or more ID fields 154 for identifying the prescription. For example, ID field 154 may be a code generated, for example, using a hash function, from the patient's name or other identifying information.

Server interface 130 is configured to receive data structures 138, 152 from scanner driver 126 and prescription entry module 128 and to send the data structures 138, 152 to server 102 by way of network interface 114. Server interface 130 may also receive an orthotic model from server 102. As will be described in further detail below, the orthotic model may be received in a CAD file format, such as stereolithography (STL), initial graphics exchange specification (IGES) or standard for the exchange of product model data (STEP). Server interface module 130 is configured to output the received orthotic model to model viewer 132 for display.

Model viewer 132 is configured to receive an orthotic model from server interface module 130 in a CAD file format and to display a representation of the solid model on interconnected display 121 using graphics adapter 120. Model viewer 132 may also receive data structure 138 containing point cloud 136 and overlay a visual representation of point cloud 136 simultaneously with a solid model. Model viewer 132 can rotate, pan, zoom and perform other transformations on the displayed representation, such that the solid model may be aligned with point cloud 136 to evaluate the fit of the foot orthotics.

Printer driver 134 is configured to be invoked by a user from solid model viewer 132. Printer driver 134 is configured to read the CAD-format orthotic model, generate instructions for causing printing device 110 to fabricate an orthotic device according to the CAD-format file, and provide those instructions to printing device 110 by way of network interface 114 or I/O interface 118.

Server 102 may be a computer running a Microsoft Windows operating system or other suitable operating system such as Linux or OSX.

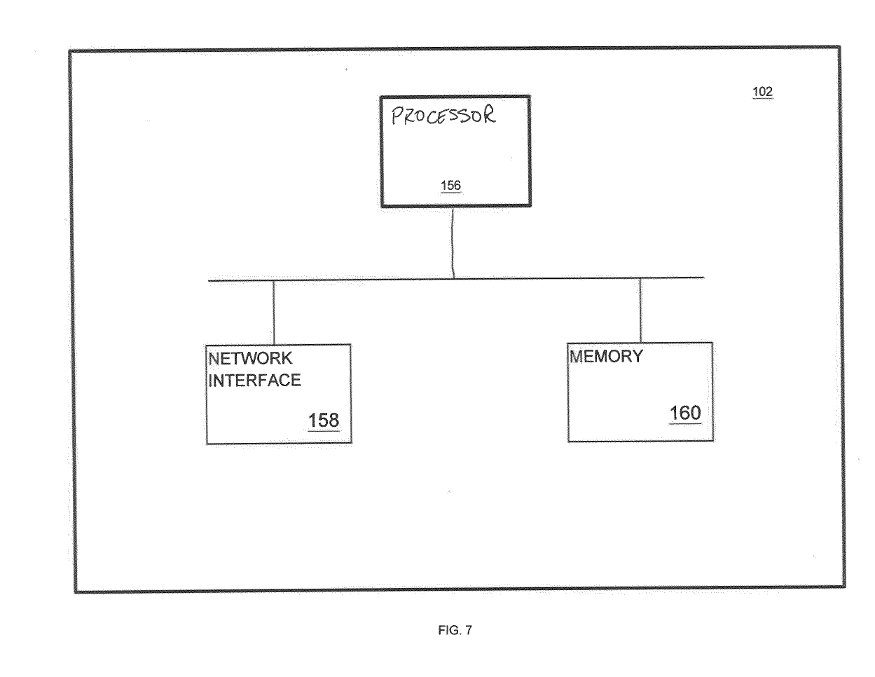

FIG. 7 depicts components of server 102 in greater detail. Server 102 includes a processor 156, a network interface 158 and a memory 160. Processor 156 may be an Intel x86, PowerPC, ARM processor or the like. Network interface 158 may, for example, be an Ethernet or WLAN adapter or cellular modem. Network interface 158 interconnects server 102 to network 106 to send and receive data. Memory 160 may be organized using a filesystem configured to store application software and data structures as will be described in greater detail below.

Server 102 executes application software loaded from a computer-readable medium 123 (FIG. 1). As will be apparent, software may be loaded from a computer-readable medium local to server 102, or may be from a computer-readable medium by way of a network connection. Loaded application software may be stored in memory 160 and subsequently accessed from memory 160. As depicted in FIG. 7, application software at server 102 includes a client interface module 140, a point cloud registration module 142, a surface contour module 144 and an orthotic model generator 146.

Client interface module 140 communicates with computing device 104 to receive data structures 138, 152 and to return a three-dimensional model of an orthotic device in a CAD file format, once the model is constructed as described below.

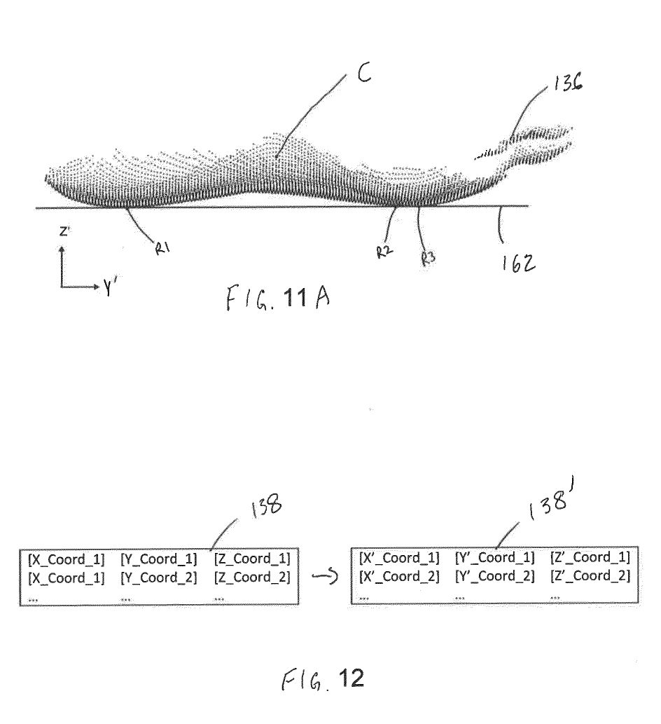

Point cloud registration module 142 is configured to receive data structure 138 from client interface module 140 and re-register the coordinates in a coordinate system aligned with the scanned foot. Specifically, point cloud registration module 142 transforms the received coordinates from an X-Y-Z coordinate system assigned by scanning device 108 to an X′-Y′-Z′ coordinate system based on anatomy of the foot, as is further described below and shown in FIGS. 11A-11B. As used herein, the term “longitudinal” refers to the Y′ axis, the terms “front”, “forward” refer to positions along the Y′ axis toward the toes, and the terms “rear” or “rearward” refer to positions along the Y′ axis toward the heel. The X′ axis is constructed to extend from the outside edge of the foot to the inside edge of the foot and corresponds to medial-lateral axis in the standard anatomical position. As used herein, the term “transverse” refers to the X′ axis, the terms “inner” or “medial” refer to the direction along the X′ axis toward the center of the body, and the terms “outer” or “lateral” refer to the direction along the X′ axis away from the center of the body. The Z′ axis is constructed to extend vertically and corresponds to the superior-inferior axis in the standard anatomical position. As used herein, the term “vertical” refers to the Z′ axis, and the terms “up”, “above” and “down”, “below” refer to directions and positions along the Z′ axis toward the head and toward the ground, respectively.

Point cloud registration module 142 identifies anatomical landmarks from point cloud 136 and constructs an anatomical coordinate system based on the anatomical landmarks, transforms the coordinates in data structure 138 according to the coordinate system, and identifies points at specific locations of interest on the scanned foot for constructing curves to form as the basis for an orthotic model surface. Point cloud registration module 142 is configured to output a modified data structure based on data structure 138, with coordinates in the anatomical coordinate system.

Surface contour module 144 receives as input the modified data structure generated by point cloud registration module 142 and data structure 152, containing orthotic parameters. Surface contour module 144 is configured to adjust coordinates of points based on orthotic parameters in data structure 152, the adjusted coordinates representing discrete points on a top surface of a custom orthotic device. Surface contour module 144 outputs a representation of the top surface, e.g., set of coordinates for points on the top surface.

Orthotic model generator 146 is configured to receive coordinates of points on orthotic contour lines from surface contour module 144 and construct a top orthotic surface model based on the received points. Orthotic model generator 146 is further configured to construct a bottom orthotic surface based on the top orthotic surface, and a subset of parameters from data structure 152, and to construct an orthotic model by combining the top and bottom orthotic surfaces. Orthotic model generator 146 outputs a representation of the model in a CAD file format, such as stereolithography (STL), initial graphics exchange specification (IGES) or standard for the exchange of product model data (STEP) to client interface module 140 for provision to fabrication facility 103 so that it can be viewed with computing device 104 and ultimately, fabricated with printing device 110.

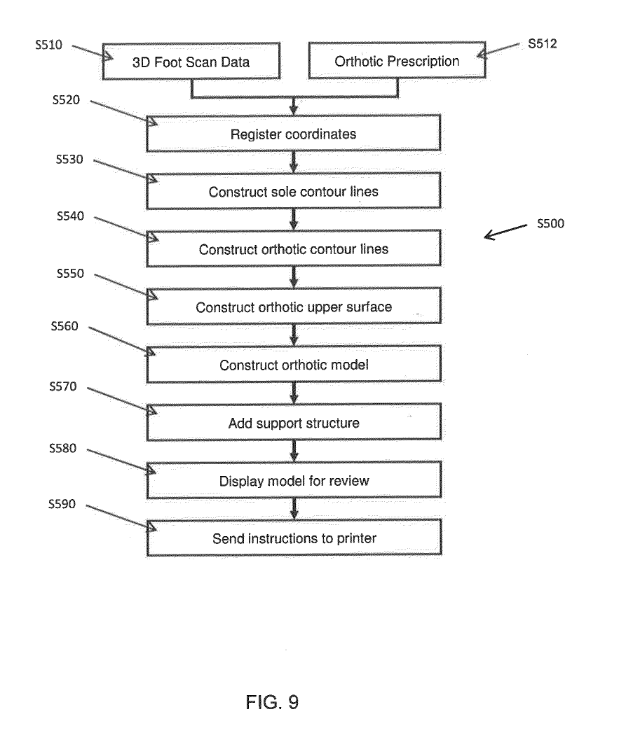

Turning now to FIG. 9, a process S500 for constructing customized foot orthotics for a specific foot is depicted. For the purpose of clarity, process S500 is described with reference only to a single foot (the “scanned foot”). However, it is to be understood that the described steps may be performed for each foot, serially or in parallel. Orthotic parameters and thus, the orthotic models described hereinafter may vary for each foot. Accordingly, a matching left-right pair may be constructed concurrently, but the resulting orthotics for each specific foot may differ.

At block S510, data is acquired at fabrication facility 103. Specifically, a specific foot is scanned using scanning device 108 to acquire a point cloud 136 of measured points on at least the plantar surface of the foot (FIG. 3). A data structure 138 is constructed, comprising three-dimensional coordinates of points in point cloud 136. As previously noted, the coordinates stored in data structure 138 are in an X-Y-Z coordinate system assigned by scanning device 108. During scanning, the foot may be placed on a guide so that the X axis aligns approximately with the transverse direction of the foot, the Y axis aligns approximately with the longitudinal direction of the foot and the Z axis aligns approximately with the vertical direction. Data structure 138 may be stored in memory 116 of computing device 104 (FIG. 2).

Many foot orthotic devices extend only to the metatarsal heads of the wearer (not beneath the wearer's toes). Accordingly, during or after scanning, a scanner operator may review a representation of the scanned points on a display and demarcate the base of the toes. Points corresponding to the toes may then be discarded from data structure 138, or an identifier may be appended to data structure 138 to identify points corresponding to the toes. Such points may then be disregarded during construction of an orthotic model. Identification of points corresponding to the toes may alternatively de done by automated processing of the scanned points.

At block S512, the foot is examined, such as by a medical doctor to ascertain pathomechanical features of the foot. Such examination may include, for example, biomechanical examination and gait analysis. Based on the examination, desired properties of a custom orthotic device for the foot are identified. An operator at computing device 104 interacts with user interface 146 to input identification information and orthotic parameters corresponding to the desired properties of the orthotic device. The entered orthotic parameters may include, but are not limited to, those depicted in FIGS. 5, 6A and 6B, namely, material of the orthotics, shell rigidity, arch shape, heel cup depth, forefoot width, heel width, rearfoot posting type, angle and amount, heel lift, forefoot posting angle and amount. Optionally, a cover (e.g. a cushion) may be applied to an orthotic device, and user interface 146 may allow for entry of characteristics of the cover, such as thickness and color. The data entered to user interface 146 is used to construct or populate a data structure 152 (FIG. 6A), which may be stored in memory 116 of computing device 104.

Data structures 138 and 152 are then provided to server 102 by way of network interface 114 of computing device 104 (FIG. 2) and network interface 158 of server 102 (FIG. 7). Point coordinates in data structure 138 represent the shape of the plantar surface of the scanned foot. As will be apparent, data structure 138 could be directly used as a model for a surface of a foot device that fits the foot (i.e., conforms to the plantar surface). However, as described herein, the contents of data structure 138 are modified to construct customized orthotics.

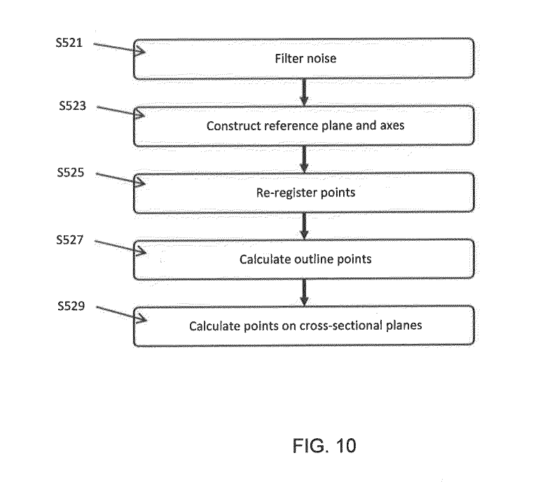

At block S520, point cloud registration module 142 loads data structure 138 and performs steps to register the coordinates of point cloud 136 to an X′-Y′-Z′ coordinate system constructed so that the X′ axis extends transversely across the scanned foot, the Y′ axis extends longitudinally along the scanned foot and the Z′ axis extends vertically. FIG. 10 depicts a process carried out by point cloud registration as part of block S520.

Typically, point cloud 136 and thus, data structure 138, includes some noisy data points introduced by the scanning process. Accordingly, at block S521, point cloud registration module 142 performs noise reduction on the received data structure 138, or replacing them with points extrapolated from neighbouring points. Such noise filtering may, for example, discard outlying points from data structure 138. Suitable noise filtering techniques are well known to those skilled in the art. Example techniques are described in Robust Filtering of Noisy Scattered Point Data, Schall, Oliver et al., Eurographics Symposium on Point-Based Graphics (2005), the entire contents of which are incorporated herein by reference.

As noted above, the point coordinates stored in data structure 138 are within an X-Y-Z coordinate system assigned by scanning device 108. At block 5523, point cloud registration module 142 constructs an anatomical X′-Y′-Z′ coordinate system based on the anatomy of the scanned foot. Specifically, as shown in FIGS. 11A and 11B, point cloud registration module 142 calculates an approximate center point C(x_{c}, x_{c}, Z_{c}) of the foot, such as by determining the mean values of the X, Y and Z coordinates of the points on the plantar surface in data structure 138. Thus, points with Y coordinates below the mean value (y_{c}) are behind center C (i.e. closer to the heel). Points with X coordinates above the mean value (x_{c}) are positioned to the right of center C and points with X coordinates above the mean value (x_{c}) are positioned to the left of center C.

Point cloud registration module 142 then constructs a reference plane 162 based on three calculated reference points R1, R2 and R3 (FIGS. 11A-11B). Reference plane 162 corresponds to the plane of the ground, i.e., reference plane 162 passes through the lowest part of the foot which contacts the ground.

FIG. 11B depicts a topographical map of Z coordinates of point cloud 136. Reference point R1 is calculated by determining the point in data structure 138 with the lowest Z coordinate behind center C (i.e. the lowest Z coordinate with a Y coordinates below the mean). Reference point R2 is calculated by determining the point in data structure 138 with the lowest Z coordinate ahead of center C and to the right of center C (i.e. the point with the lowest Z coordinate with X and Y coordinates above the mean). Reference point R3 is calculated by determining the point in data structure 138 with the lowest Z coordinate ahead of center C and to the left of center C (i.e., the point with the lowest 2 coordinates with Y value above the mean and X value below the mean).

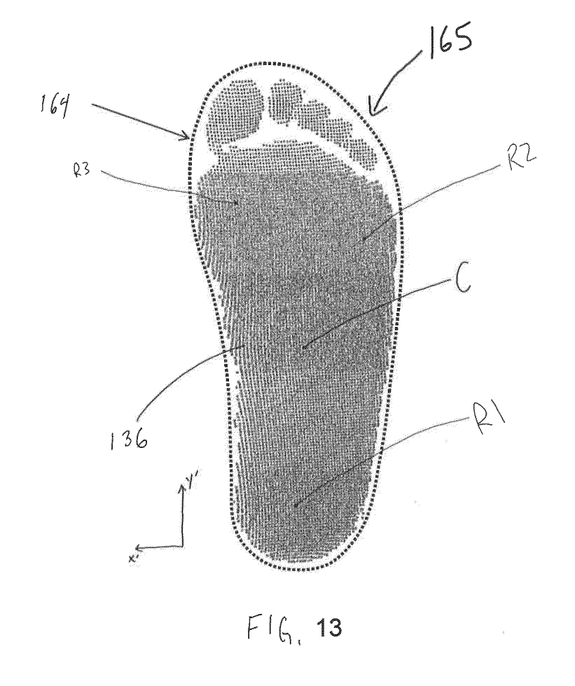

Referring to FIGS. 11A, 11B, reference plane 162 is then constructed by calculating a plane containing reference points R1, R2 and R3. A new Z′ axis is constructed normal to reference plane 162 and passing through center C, with Z′=0 at reference plane 162. Hereinafter, the Z′ axis is referred to as the vertical axis. A new Y′ axis is constructed by calculating a line in reference plane 162 that passes from reference point R1 through the X, Y coordinates of center C. Hereinafter, the Y axis is referred to as the longitudinal axis. A new X′ axis is constructed by calculating a line in reference plane 162 that is perpendicular to the Y′ axis and passes through the X,Y coordinates of center C (see FIG. 13).

The X′ and Y′ axes define an X′-Y′ plane parallel to reference plane 162. The Y′ and Z′ axes define a Y′-Z′ plane which extends in the longitudinal and vertical directions of the foot. The X′ and Z′ axes define an X′-Z′ plane which extends in the transverse and vertical direction of the foot.

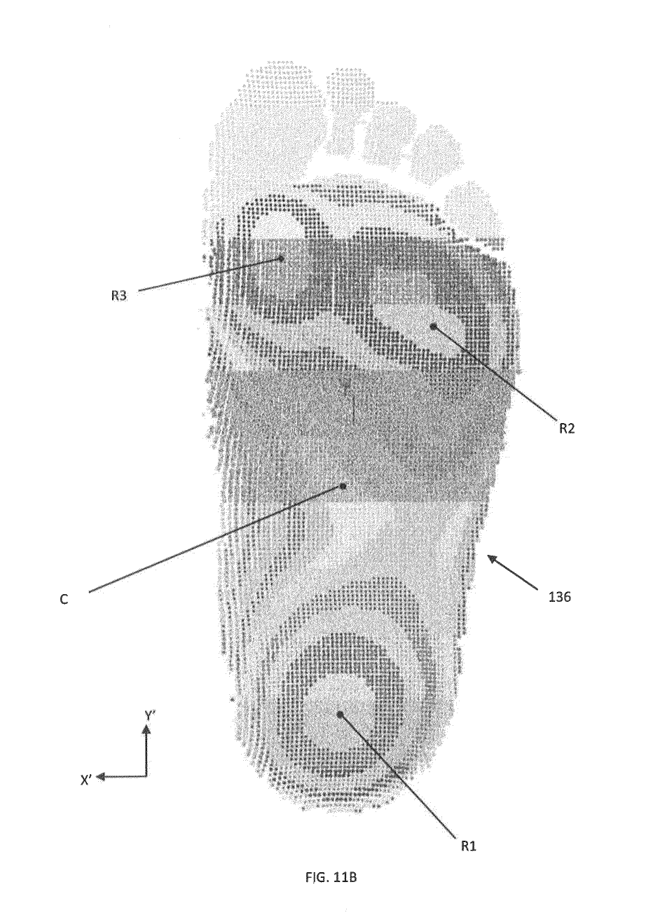

At block S525, point cloud registration module 142 constructs a modified data structure 138′ by re-registering (mapping) the points of data structure 138 from the original, scanner-defined X-Y-Z coordinate system to the anatomical X′-Y′-Z′ coordinate system as shown in FIG. 12.

At block S527, and as depicted in FIG. 13, point cloud registration module 142 additionally appends a plurality of outline points 164, horizontally offset by a predetermined distance (e.g. 3 mm) from the outermost points in point cloud 136. For each value of Y′, point cloud registration module 142 determines the points in data structure 138′ with the smallest and largest X′ coordinates. Point cloud registration module 142 then calculates a closed curve through the boundary points and offsets the resulting curve by the predetermined distance to define a set of outline points 164 which lie on an outline curve 165. Outline points 164 are appended to data structure 138′. The closed curve may for example be constructed by calculating a B-spline using the SISL library by SINTEF of Norway with the set of boundary points.

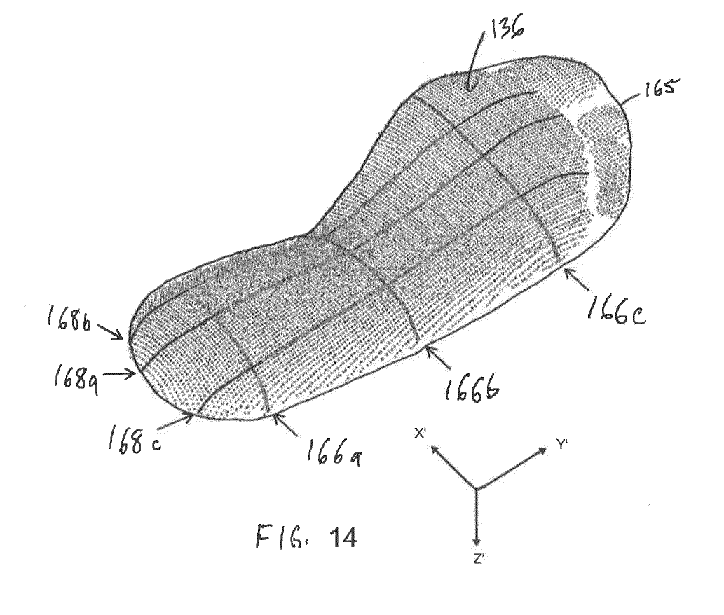

At block S529, point cloud registration module 142 further identifies points in data structure 138′ which lie on specific cross-sectional planes. For example, as depicted in FIG. 14, each one of transverse curved lines 166a, 166b, 166c denotes points which lie in a X′-Z′ cross-sectional plane, and each one of longitudinal curved lines 168a, 168b, 168c denote points which lie in an Y′-Z′ cross-sectional plane. Curved line 166a passes through each point aligned in the Y′ axis with reference point R1; curved line 166b passes through each point aligned in the Y axis with the point having the highest Z′ value; and curved line 166c extends through each point aligned in the Y′ axis with point having the lowest Z′ value ahead of center C, i.e. with a Y′ value larger than that of C. Each of curved lines 166a, 166b, 166c extends in a plane parallel to the X′-Z′ plane. Curved line 168a extends through reference point R1 and center C, and extends in a plane parallel to the Y′-Z′ plane. Curved line 168b extends in a plane parallel to the Y′-Z′ plane and is spaced inwardly from curved line 168a. Curved line 168c extends in a plane parallel to the Y′-Z′ plane and is spaced outwardly from curved line 168a. As depicted, curved lines 168b and 168c are spaced apart from curved line 168a by one-quarter of the width of the scanned foot. However, in other embodiments, curved lines 168b, 168c may be spaced apart differently. Points belonging to each one of curved lines 166, 168 are identified by point registration module 142. Data structure 138′ may be modified to store identifiers of such points. Alternatively, identifiers may be stored in a separate data structure (not shown).

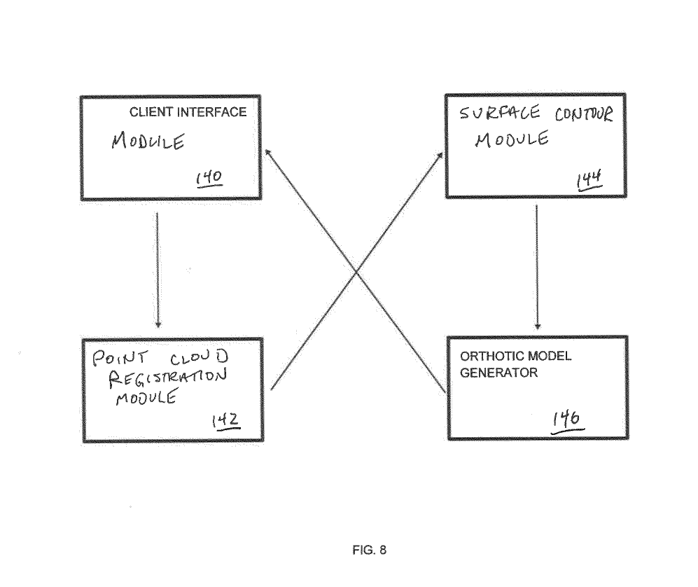

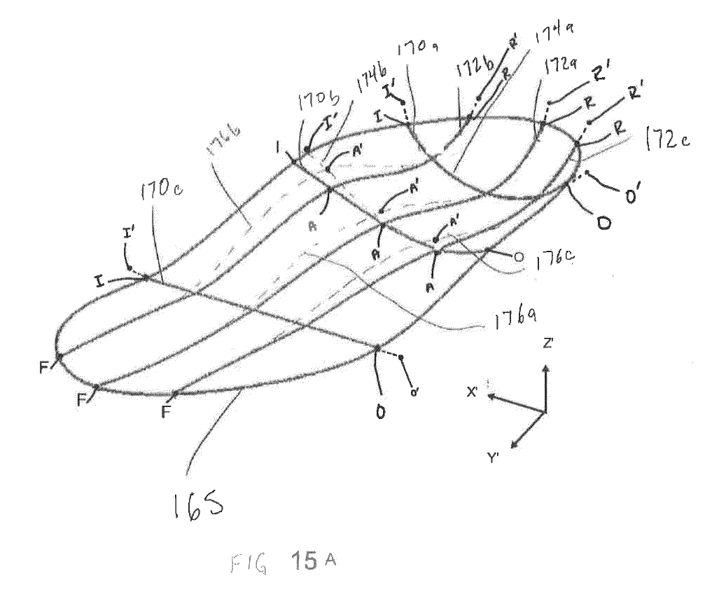

Referring again to FIG. 9, at block S530, surface contour module 144 (FIG. 8) loads data structure 138′ from point cloud registration module and, as depicted in FIG. 15A, constructs a plurality of sole contour lines corresponding to the shape of the scanned foot.

Surface contour module 144 uses the points on each of curved lines 166a, 166b, 166c to construct corresponding B-spline curves 170a, 170b, 170c (collectively, B-spline curves 170) and uses the point on each of curved lines 168a, 168b, 168c to construct corresponding B-spline curves 172a, 172b, 172c (collectively, B-spline curves 172). Each of B-spline curves 170, 172 may for example be constructed using the SISL library by SINTEF of Norway with the set of points on the corresponding curved line 166, 168. B-spline curves 170, 172 correspond to the shape of the sole of the scanned foot. B-spline curves 170, 172 may be stored in a data structure comprising a series of 3-dimensional X′-Y′-Z′ coordinates, which may be in the same format as data structure 138′.

Each of B-spline curves 170 has an inner endpoint I and an outer endpoint O. B-spline curve 170b, which passes through the arch region, has a point A corresponding to the highest point on the curve in the arch region.

Each of B-spline curves 172 has a front endpoint F and a rear endpoint R, and a point A corresponding to the highest point on each respective curve in the arch region.

At block S540, surface contour module 144 modifies the B-spline curves 170, 172 to construct orthotic contour lines 174 (174a, 174b, 174c) and 176 (176a, 176b, 176c). The modifications to sole B-spline curves are based on orthotic parameters in data structure 152. In an example, the modifications are based on arch height, heel cup depth, forefoot width and rearfoot width parameters.

FIGS. 15A-15E show an example set of B-spline curves 170, 172 and, in broken line, corresponding orthotic curves 174, 176. FIG. 15B shows curves 170a, 174a in detail; FIG. 15C shows curves 172a, 176a in detail; FIG. 15D shows curves 170b, 174b in detail; and FIG. 15E shows curves 170c, 174c in detail. The modifications to curves 172b, 172c to create curves 176b, 176c are similar to those depicted in FIG. 15C and are therefore not separately shown in detail. The modified position of each respective point is denoted by the prime (′) symbol.

Surface contour module 144 adjusts inner and outer endpoints I and 0 of B-spline curve 170a and rear endpoints R of each of B-spline curves 172a, 172b, 172c based on the heel cup depth parameter in data structure 152.

If, as depicted, the heel cup depth parameter specifies increased depth, surface contour module 144 extrapolates from each of B-spline curves 170a, 172a, 172b, 172c to add points so that the Z′ coordinates of each endpoint R′ and of endpoints I′, O′ are increased relative to the corresponding endpoints R and I, O. FIGS. 15B-15C depict example curves 170a, 174a and 172a, 176a, respectively. The modifications to curves 172b and 172c are similar to the modifications to curve 172a and are therefore not shown in detail.

Conversely, if the heel cup depth parameter specifies decreased depth, surface contour module 144 discards endpoints on each of B-spline curves 170a, 172a, 172b, 172c so that the Z′ coordinates of the new endpoints R′ and the new endpoints I′, O′ are reduced relative to the corresponding old endpoints R and I, O.

Surface contour module 144 applies a function to vertically adjust points in each of curves 170b, 172a, 172b, 172c based on the arch height parameter.

As depicted in FIG. 15D, curve 174b is created by vertically adjusting points in curve 170b as a function of the arch height parameter and X′ axis coordinate. The inner end point I is vertically adjusted by the full distance specified by the arch height parameter. Other points are adjusted by distances which progressively decrease with increasing distance from end point I.

As depicted in FIG. 15C, curve 176a is created by vertically adjusting points in curve 172a as a function of the arch height parameter and distance from curve 170b. Curves 170b, 172a share a point where they intersect and curve 172a is adjusted at the point of intersection based on the adjustment to curve 170a. Other points are adjusted by distances which progressively decrease with increasing distance from curve 170b. The amount of adjustment for each point may be linearly or otherwise dependent on its distance to curve 170b.

The vertical adjustments to curves 170b, 172 may be upward, as depicted, in the case of parameter specifying increased arch height or downward in the case of a parameter specifying decreased arch height. As noted, the adjustments are a function of Y′ coordinate for curves 172 and of X′ coordinate for curve 170b and some points may be adjusted very small distances or not at all.

Surface contour module 144 adjusts the X′ coordinates of endpoints I, O of curve 170c based on the forefoot width parameter. As depicted in FIG. 15E, endpoint I is moved in the medial direction and endpoint O is moved in the lateral direction, reflective of the forefoot width parameter specifying that the forefoot should be widened. Alternatively, if the forefoot width parameter specifies narrowing, endpoint I is moved in the lateral direction and endpoint O is moved in the medial direction.

Surface contour module 144 adjusts endpoints I, O of curve 170a based on the rearfoot width parameter. The adjustments based on rearfoot width are similar to the adjustments based on heel cup depth, described above with reference to FIG. 15B. Specifically, if the rearfoot width parameter specifies widening, surface contour module 144 extrapolates from curve 170a to add points so that endpoint I′ is located inwardly of endpoint I and endpoint O′ is located outwardly of endpoint O. Conversely, if the rearfoot width parameter specifies narrowing, surface contour module 144 discards points from curve 170a so that the Z′ coordinates of endpoints I′ is located outwardly of endpoint I and endpoint O′ is located inwardly of endpoint O.

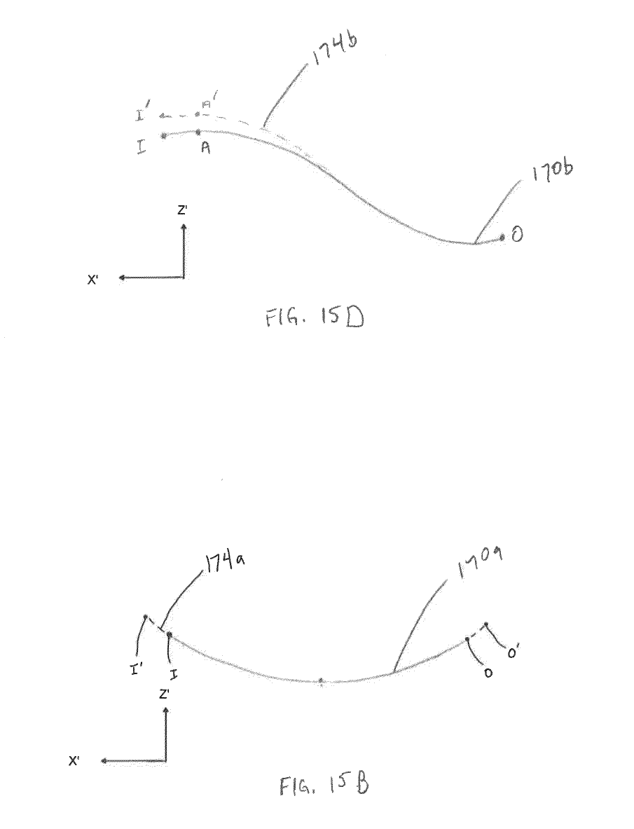

Once orthotic curves 174, 176 are calculated, surface contour module 144 constructs an adjusted outline curve 173 (FIG. 16) by calculating a B-spline curve with outline points 164 and adjusted endpoints I′, O′ and R′ of orthotic curves 174, 176.

Orthotic contour lines 174, 176 and outline curve 173 may be stored in a data structure comprising a series of 3-dimensional X′-Y′-Z′ coordinates, which may be in the same format as data structure 138′.

At block S550, orthotic model generator 146 receives orthotic contour lines 174, 176 and constructs a top, orthotic surface model 178 based on orthotic contour lines 174, 176 as depicted in FIG. 16. The top orthotic surface model may be constructed as a non-uniform rational B-spline (NURBS) surface or polygon mesh.

To generate top surface model 178, orthotic model generator 146 calculates additional transverse orthotic surface contours 175 and longitudinal orthotic surface contours 177 based on points in orthotic contour lines 174, 176 and outline curve 173.

Each of transverse orthotic surface contours 175 extends in a plane parallel to the X′-Z′ plane at a particular Y coordinate and is constructed by calculating a B-spline curve using inner and outer points on outline curve 173 at that Y′ coordinate and points on each of orthotic surface contours 176a, 176b, 176c at that Y coordinate.

Each of longitudinal orthotic surface contours 177 extends in a plane parallel to the Y′-Z′ plane at a particular X′ coordinate and is constructed by calculating a B-spline curve using front and rear points on outline curve 173 at that Y′ coordinate and points on each of orthotic surface contours 174a, 174b, 174c at that X′ coordinate.

Orthotic contour lines 175, 177 may be stored in a data structure comprising a series of 3-dimensional X′-Y′-Z′ coordinates, which may be in the same format as data structure 138′. Orthotic contour lines 175, 177 may be evenly spaced along the length and width of the foot and model generator 146 may continue to construct sufficient orthotic contour lines 175, 177 so that the distance between adjacent contour lines is a predetermined step size. In an example, the step size is 3 mm. However, the step size may typically be between 2 mm and 5 mm.

Orthotic model generator 146 constructs a surface mesh comprising a plurality of polygons. Each polygon is constructed by selecting neighbouring points on orthotic contour lines 174, 176 and orthotic surface contours 175, 177 and outline curve 173 and forming polygons from the selected points, until the entire orthotic surface 178 is occupied by such polygons. Any suitable polygon modelling technique may be used. Such techniques for constructing a surface mesh defined by a plurality of polygons are well known to skilled persons and are therefore not described in detail. Example techniques for producing a 3D mesh of polygons are discussed in Meshing Point Clouds Using Spherical Parametrization, Zwicker, M. and Gotsman, C., Eurographics Symposium on Point-Based Graphics (2004), the entire contents of which are incorporated herein by reference. As depicted, surface 178 is defined by a mesh of four-sided polygons. However, the mesh may instead be formed of three-sided polygons, or of polygons having a larger number of sides. In some embodiments, triangular polygons may be more convenient to use for constructing 3D surfaces. Any suitable polygon modelling technique may be used for constructing the surfaces from a given set of 3D surface points.

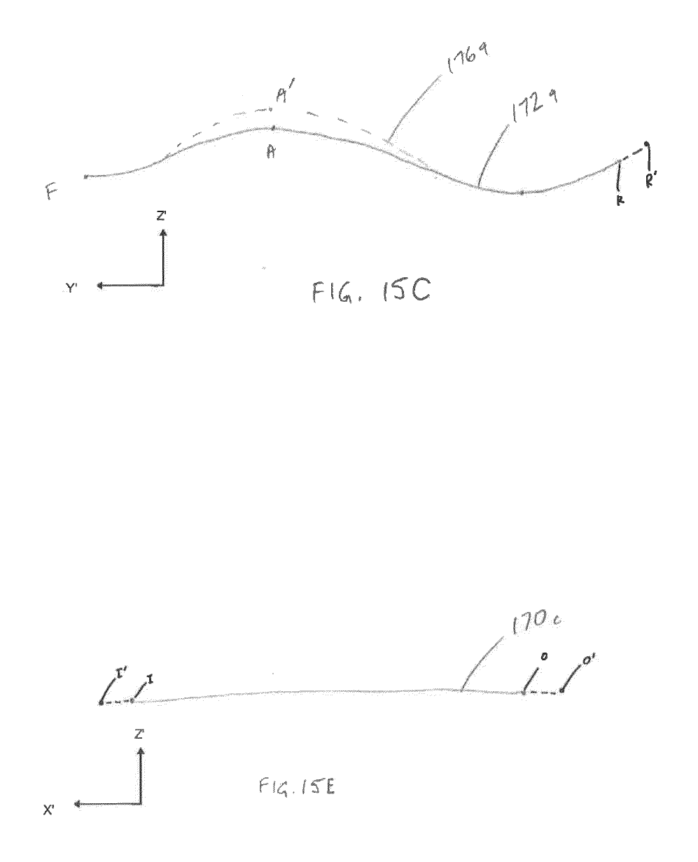

Orthotic model generator 146 then constructs a bottom surface 180 offset from the top surface downwardly as depicted in FIG. 17 and then constructs an orthotic model 182 by joining top surface 178 and bottom surface 180. The distance of the offset defines the thickness of orthotic model 182 and is determined based on the stiffness parameter in data structure 152. In an example, bottom surface 180 is offset by 2.5 mm for an orthotic of standard thickness. Typically, bottom surface 180 is offset from top surface 178 by 2.3-2.6 mm. However, in some embodiments, bottom surface 180 may be offset by a greater distance, e.g. 2.7-3.7 mm, to provide added stiffness. Orthotic model generator 146 trims orthotic model 182 as shown in FIG. 17 so that the front edge of the orthotics corresponds to the metatarsal heads of the wearer's foot.

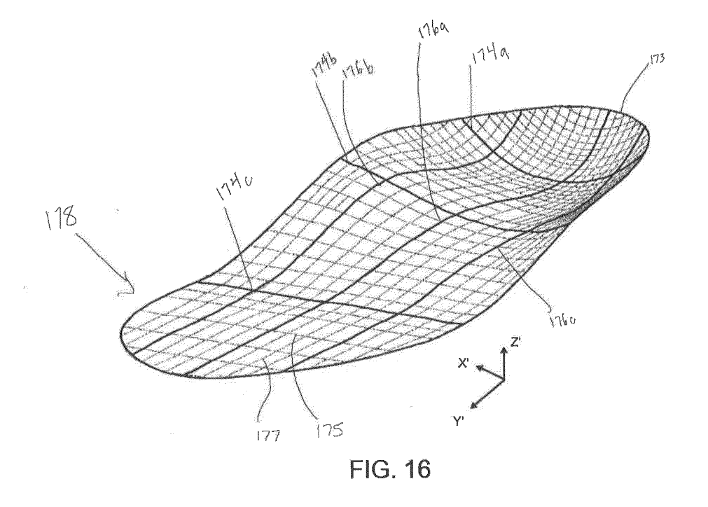

Once orthotic model 182 is constructed, orthotic model generator 146 modifies orthotic model 182 in accordance with a subset of parameters in data structure 152. For example, depending on the parameters in data structure 152, orthotic model generator 146 may add rearfoot posting 184. Rearfoot posting 184 may be extrinsic, as depicted in FIG. 18, or intrinsic. Orthotic model generator 146 may also add forefoot posting 188 and may add one or more reinforcing members 186 based on whether data structure 152 specifies added stiffness. Rearfoot posting 184, forefoot posting 188 and reinforcing members 186 are defined by three-dimensional surfaces, shapes or curves corresponding to specific subsets of orthotic parameters in data structure 152. For example, orthotic model generator 146 may have a pre-defined set of possible rearfoot posting shapes, each corresponding to a specific combination of parameters, namely, type (intrinsic or extrinsic), direction (varus, valgus or neutral), amount, and heel lift. Similarly, orthotic model generator may have a pre-defined set of possible forefoot posting shapes, each corresponding to a specific combination of parameters, namely, direction (varus, valgus or neutral) and amount, and a pre-defined set of possible shapes of stiffening structures, each corresponding to a degree of stiffening.

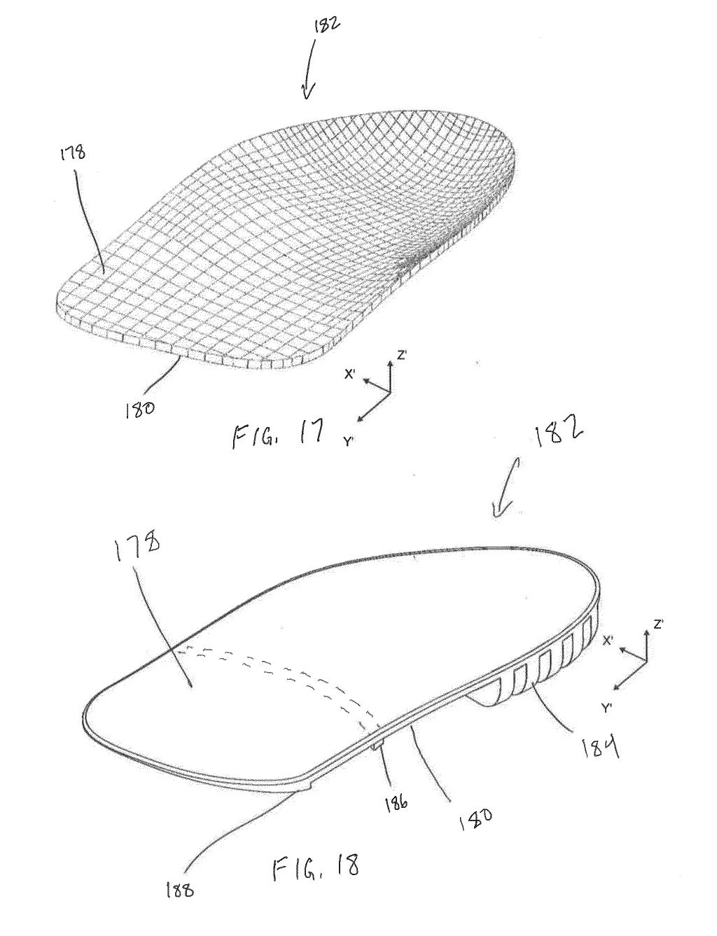

At block S570, orthotic model generator 146 adds a support structure to orthotic model 182. FIG. 19 shows a process of adding a support structure to orthotic model 182.

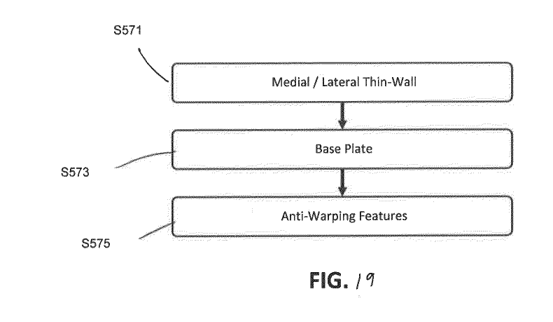

At block S571, a thin wall structure 194 is added along the inner (medial) edge of orthotic model 182. As shown in FIG. 20, thin wall structure 194 extends transversely in the medial direction.

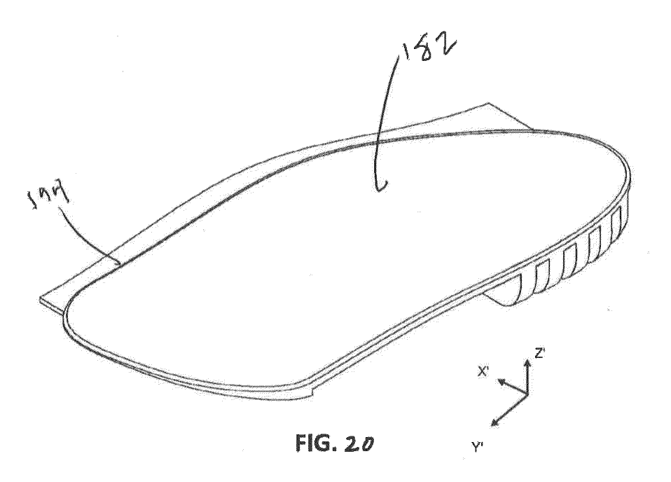

At block S573, a base plate 196 is added to an edge of thin wall structure 194 as shown in FIG. 21. As depicted, base plate 196 is added to the medial edge, but base plate 196 may alternatively be added to the lateral edge. Base plate 196 is substantially thicker than thin wall structure 194. In an example, thin wall structure 194 may be 2-3 mm thick and base plate 196 may be 5-7 mm thick.

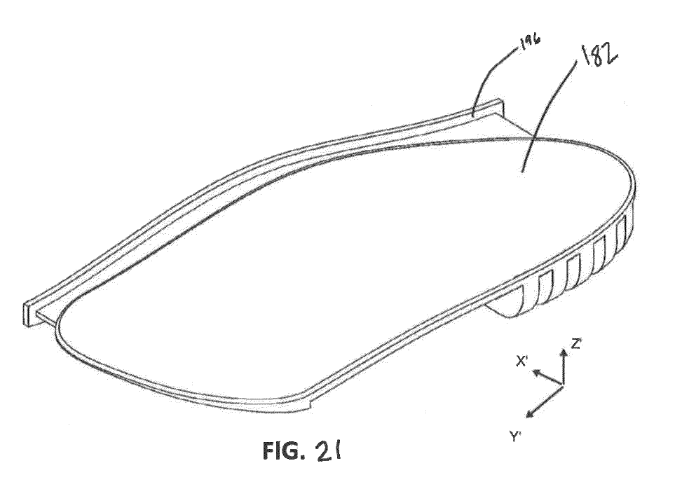

At block S575, extensions 198 are added to each end of base plate 196 as shown in FIG. 22. Thin wall structure 194, base plate 196 and extensions 198 together form a support structure 199 for supporting the orthotic device during fabrication (e.g. during 3D printing).

Orthotic model 182 and support structure 199 may be stored in a CAD file format, such as stereolithography (STL), initial graphics exchange specification (IGES) or standard for the exchange of product model data (STEP). Client interface module 140 provides the model in this format to computing device 104 for display and ultimately, fabrication. For simplicity, FIGS. 18 and 20-22 depict the outline of orthotic model 182 and support structure 199, but do not depict constituent points, curves or polygon meshes. As will be apparent, orthotic model 182 and support structure 199 may be represented by any combination of points, curves and polygons, depending on the file format in which they are stored.

At block S580, computing device 104 receives orthotic model 182 and support structure 199 in CAD-compatible format and model viewer 132 presents a representation of the model on an interconnected display, such as display 121, using graphics adapter 120 (FIG. 2). The orthotic model 182 may be presented in a user interface which also includes a representation of point cloud 136. The user interface may allow orthotic model 182 and point cloud 136 to be rotated, panned or zoomed relative to one another so that an operator can align orthotic model 182 with point cloud 136 to asses fit.

The user interface may also display a print control. If the operator of computing device 104 is satisfied with orthotic device 182, the operator can activate the print control to send instructions to printing device 110.

Alternatively, if the operator is not satisfied with orthotic device 182, the operator may enter modified parameters corresponding to desired characteristics to be provided to server 102 as a modified data structure 152. Optionally, modifications may be entered by way of the user interface presented by model viewer 132. For example, modifications may be entered in a dialog. Alternatively, the operator may return to block S510 and enter new parameters by way of user interface 146 (FIG. 5).

Optionally, on receiving modified data structure 152, server 102 may load the relevant registered point cloud data and resume process S500 beginning at block S540, using the modified data structure 152. Alternatively, server 102 may repeat process 500 from block 520.

At block S590, model viewer 132 sends orthotic model 182 and support structure 199 to printing device 110 to cause printing device 110 to fabricate a custom orthotic device in accordance with orthotic model 182. Printer driver 134 may translate the orthotic model from a CAD-file format to instructions in a format readable by printing device 110.

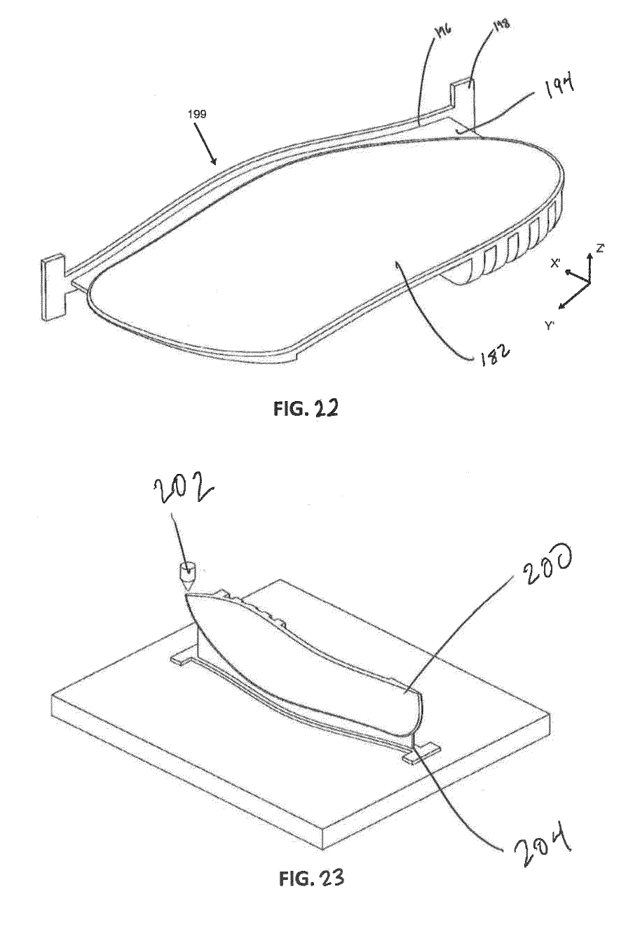

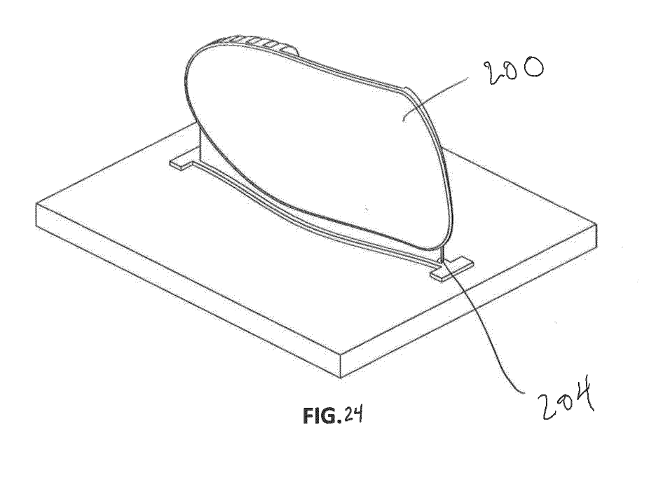

FIGS. 23-24 depict fabrication of a custom orthotic device 200 by printing device 110. In the depicted example, printing device 110 is a fused deposition modelling (FDM) 3D printer (not shown in its entirety in FIGS. 23-24). Printing device 110 deposits print material layer-by-layer through a print nozzle 202. The orthotic device 200 is thus built up in layers, beginning with support structure 204 according to modelled support structure 199, and proceeding across orthotic device 200 in the transverse direction as previously defined, from its inner (medial) edge to its outer (lateral) edge. In the depicted example, each layer is approximately 0.2 mm thick. However, in other embodiments, the layer thickness may be varied.

After printing, support structure 204 may be removed from the completed orthotic device 200, for example by cutting or grinding.

Conveniently, the above-described system and process provides an opportunity for review of a prospective orthotic model prior to fabrication. For example, a user of system 100 may be a podiatrist, who may examine and scan a foot and enter an initial set of orthotic parameters using user interface 146 at computing device 104. Server 102 constructs custom orthotics for the foot according to the scanned model and the initial orthotic parameters and returns an orthotic model. The podiatrist may then evaluate the returned model by aligning and comparing it with the scanned foot, for example, as represented by the point cloud 136. The orthotic parameters may then be altered as necessary and a new orthotic model is constructed based on the scanned foot and the revised parameters. If the new orthotic model is satisfactory, an orthotic device is fabricated based on the new orthotic model. Thus, a design may be quickly constructed and tested. In contrast, design by physical prototyping may be relatively slow and a design cannot be tested until a physical prototype is produced.

Moreover, the disclosed design process can be tailored for computational efficiency. For example, applying orthotic parameters to curves prior to constructing an orthotic surface may limit the computational resources required for the design process. For at least some types of orthotic parameters, modifying an already-constructed surface, rather than the curves from which a surface is constructed, may be relatively more computationally intensive.

As described above, custom orthotics are constructed using three transverse lines 166, three corresponding transverse curves 170 and three corresponding transverse orthotic contour lines 174, and three longitudinal lines 168, three longitudinal curves 172 and three longituorthotic contour lines 176. In other embodiments, custom orthotics may be constructed using a larger number of transverse lines 166, curves 170 and orthotic contour lines 174, and a larger number of longitudinal lines 168, curves 172 and orthotic contour lines 176. The number of lines, curves and contours in each direction is selected to provide an orthotic model of acceptable fit and smoothness. Greater numbers may allow for more detailed surfaces, but excessive numbers may result in roughness. The number of lines, curves and contours in the transverse direction may differ from the number of lines in the longitudinal direction.

In some embodiments, curves 170, 172 may be constructed using only subsets of the points on lines 166, 168. For example, each of curves 170, 172 could be constructed by calculating a B-spline using a certain number of points (e.g. 5) along the corresponding line 166 or 168.

In some embodiments, curves 170, 172 may be constructed using functions other than B-splines. For example, each of curves 170, 172 may be constructed by fitting curves to a set of points from the corresponding line 166 or 168. Fitting curves may be done, for example, by calculating coefficients for polynomial or other mathematical functions. Such functions may be selected to provide a certain number of degrees of freedom based on the number of control points to which the functions are to be fit. For example, a function to be fit to 5 points may be selected to have no more than four degrees of freedom.

In some embodiments, pre-defined curves can be used to adjust the shape of curves 170a and 170b to match the proper heel cup depth and arch height requirements.

As described above, server 102 and fabrication facility 103 are connected over a network 106. Server 102 and computing device 104 are separate computers. However, in other embodiments, the functions of server 102 and computing device 104 may be carried out by a single computer. In such embodiments, data exchanges described above as occurring over network 106 may occur between applications on a single machine, within memory.

It will be apparent that the components of fabrication facility 103 need not be physically located together. In some embodiments, printing device 110 or scanning device 108 may be located remotely from computing device 104. For example, scanning device 108 and computing device 104 may be located in an office and printing device 110 may be remotely located at another facility.

As described above, printing device 110 is a 3D printer. However, other fabrication devices may be used. For example, printing device 110 could be any additive manufacturing device, or even a conventional manufacturing device such as a computer-numeric-controlled (CNC) mill. In such embodiments, printer driver 134 may be replaced with a module configured to control the specific fabrication device.

An embodiment of the disclosure relates to a process of constructing foot orthotics. In a typical process, a subject, such as a patient, visits a podiatrist or another medical professional at the professional's office such as a foot clinic. One or both feet of the patient can be examined and scanned using a suitable foot scanner in the clinic. The professional prepares a prescription form containing patient information and foot orthotic parameters for custom foot orthotics for each scanned foot of the patient. A 3D image or model of the scanned foot and the corresponding prescription form are input into a user terminal at the clinic and communicated to an off-site server for constructing an orthotic model for each scanned foot. The server may construct the orthotic model as described herein. The orthotic model is then communicated from the server to the user terminal at the clinic. The medical professional may view the orthotic model on a computer display and may overlay (superimpose) the orthotic model with the scanned image of the corresponding foot to see how they fit. Based on this review, the medical professional may revise the orthotic prescription and send the revised prescription and the scanned model to the server to construct a revised orthotic model. Once the professional is satisfied with the orthotic model received from the server, the orthotic model may be loaded to an automated fabrication device such as a 3D printer to fabricate an orthotic device based on the orthotic model. Alternatively, the off-site server may be replaced with a local computing device located on site in the clinic. Conveniently, a podiatrist may have an opportunity to review and modify the orthotics before a physical orthotic device is fabricated. The patient may be able to receive and try the orthotic device within a short period of time, such as within one or two days. In some embodiments, a system including devices for scanning, model construction, and fabrication can be all provided at one location, and the location can be at or near the clinic. In some embodiments, a dedicated off-site server for model construction may be used to serve a large number of medical professionals or foot clinics at different locations. This may allow the users to share the costs of developing and maintaining a more sophisticated modelling construction software, and allow the fabrication processes and products to be more conveniently standardized.

A further embodiment of the disclosure relates to a system for constructing foot orthotics. The system includes a data acquisition module or component for acquiring data structures representing a foot plantar surface or a contoured surface on an foot orthotics (a 3D orthotic model or an orthotic device), and representing orthotic parameters for constructing or modifying the foot orthotics. The system also includes a model construction component for electronically constructing or modifying 3D orthotic models. The model construction component may be configured and adapted to perform the functions and steps described above with reference to server 102. The system further includes a fabrication component for fabricating foot orthotic devices based on 3D orthotic models constructed by the model construction component. The components of the system may be connected for inter-communication as needed. Each component of the system may be provided by a combination of hardware and software. One or more of components of the system may be integrated into one device or apparatus. The system may also be a distributed system. For example, one or more of the components of the system may be provided in separate devices and functions of a component may be performed by different devices at different locations. In particular, computing steps may be distributed over networked computers or devices. Some computing functions may be performed by hardware or software, or a combination of hardware and software. The system may be provided in part by a cloud computing technique. The system may require individual users of the system to pre-register, such as with a user management component of the system. The user may be assigned an identification (ID) (e.g. a username) and a security code (e.g. a password). The scanned foot models and corresponding constructed orthotic models may be stored centrally or otherwise in association with information of the particular user who made the initial request and the particular patient of the user. The stored information may be retrievable at a later point in time. The stored information may also be analysed to improve the modelling procedure (such as the modelling algorithm) or standardize the modelling procedure. The stored information may also be used to provide improvements to new orthotics for the same patient based on feedback from the user or patient with or without a new scan. The system may also provide a material or product ordering and delivering component for the users to order materials or components used to scan a foot or to make a foot orthotic device. For example, a user may order scanners, printers, printing materials or the like through the ordering component of the system. The system may provide a user interface for the users to conveniently interact with the system.

Other embodiments will be apparent, in which an initial computerized model of a contoured foot surface is received along with parameters for constructing a foot orthotic device and coordinates of points on the foot surface are adjusted based on curves derived from the parameters, the adjusted points defining a surface of a customized foot orthotic device, which can then be provided to a facility for fabrication.

It should be clarified that in this disclosure a point is considered to be “along” a line or a plane if the point is on the line or in the plane. A point may also be considered to be along a line if the point is not exactly on the line but is close to or near the line within a given distance, which may be pre-defined. In some cases, a particular point may be considered to be along the line if the particular point is closer to the line than any other points under consideration. Similarly, a point or a line may be considered to be along or in a plane if the point or line is close to or near the plane within a given distance, which may be pre-defined. In some cases, a particular point or line may be considered to be in the plane if the particular point or line is closer to the plane than any other point or line under consideration. For example, as can be appreciated, the points in a point cloud, particularly a scanned 3D point cloud after re-registration in a different coordinate system, may not be perfectly aligned with the given coordinate axes or a reference surface. Therefore, some allowance may be required to account for the imperfect alignment. It may not be necessary in all cases for a point to be exactly on a line in order for the point to be included as a part of the line for fitting purposes. Similarly, it may not be necessary in all cases for a line to be exactly in a plane in order for the line to be included as a part of the plane for fitting purposes.

A fabrication facility may be as simple as a general purpose 3D printer, but may also be a dedicated installation with a special-purpose fabrication device or a sophisticated manufacturing plant.

It will be understood that any range of values disclosed herein is intended to specifically include any intermediate value or sub-range within the given range, and all such intermediate values and sub-ranges are individually and specifically disclosed.

It will also be understood that the word “a” or “an” is intended to mean “one or more” or “at least one”, and any singular form is intended to include plurals herein.

It will be further understood that the term “comprise”, including any variation thereof, is intended to be open-ended and means “include, but not limited to,” unless otherwise specifically indicated to the contrary.

When a list of items is given herein with an “or” before the last item, any one of the listed items or any suitable combination of two or more of the listed items may be selected and used.

Other modifications to the above-described embodiments are possible. The invention is therefore defined by the claims, which should be given a broad interpretation consistent with the description as a whole.

What is claimed is:

1. A method of constructing a customized foot orthotic model for a foot, comprising:
receiving an initial model for a contoured surface of a foot device that fits a plantar surface of a specific foot, said initial model comprising data representing three-dimensional coordinates of a plurality of discrete points on the contoured surface;
receiving a plurality of orthotic parameters for constructing a foot orthotic device customized for the specific foot;
electronically obtaining coordinates of selected ones of said discrete points distributed along selected longitudinal and transverse lines on said contoured surface, and electronically adjusting vertical coordinates of said selected points based on a first subset of said orthotic parameters;
electronically constructing a foot orthotic model comprising data representing an orthotic surface of said foot orthotic device, said orthotic surface constructed based on said selected points with adjusted coordinates; and
providing said foot orthotic model to a fabrication facility for automated fabrication of said foot orthotic device based on said foot orthotic model.

2. The method of claim 1, wherein said selected lines comprise three longitudinal lines and three transverse lines.

3. The method of claim 1, comprising:
determining a reference plane, a longitudinal axis, and a transverse axis for said contoured surface, wherein said reference plane is parallel to said longitudinal axis and said transverse axis and is perpendicular to a vertical axis for said contoured surface; and
re-registering said plurality of discrete points in a coordinate system such that each one of said longitudinal lines is in a corresponding plane parallel to said longitudinal axis and said vertical axis, and each one of said transverse lines is in a corresponding plane parallel to said transverse axis and said vertical axis.

4. The method of claim 3, wherein said each line is determined using a spline function and control points distributed along said corresponding plane.

5. The method of claim 1, comprising partitioning said contour surface into a heel section and a forefoot section, and wherein said reference plane is defined by a bottom point in said heel section, a lateral bottom point in said forefoot section, and a medial bottom point in said forefoot section.

6. The method of claim 5, wherein said orthotic parameters comprise an arch shape parameter, a heel cup depth parameter, a forefoot width parameter or a heel width parameter; and wherein vertical coordinates of said selected points in said arch section are adjusted based on said arch shape parameter, said heel section is trimmed or extended based on said heel cup depth parameter, said forefoot section or said heel section is narrowed or widened based on said forefoot width parameter or said heel width parameter.

7. The method of claim 1, wherein said constructing comprises electronically generating additional surface points for said orthotic surface by extrapolation based on said selected points.

8. The method of claim 1, wherein said foot orthotic model further comprises data representing a bottom surface opposite to said orthotic surface, said bottom surface constructed based on a pre-defined surface and a second subset of said orthotic parameters.

9. The method of claim 8, wherein said orthotic parameters comprise a posting parameter, and said bottom surface is tilted, or includes a posting for raising said heel or forefoot section, based on said posting parameter.

10. A computing device comprising:
a processor;
an input/output device in communication with said processor;
a memory in communication with said processor; and
processor-executable code stored in said memory, which, when executed by said processor, causes said computing device to:
receive, over said input/output device, a first data structure comprising an initial model for a contoured surface of a foot device that fits a plantar surface of a specific foot, said initial model comprising data representing three-dimensional coordinates of a plurality of discrete points on the contoured surface;
receive, over said input/output device, a second data structure comprising a plurality of orthotic parameters for constructing a foot orthotic device customized for the specific foot;
obtain coordinates of selected ones of said discrete points distributed along selected longitudinal and transverse lines on said contoured surface, and adjust vertical coordinates of said selected points based on a first subset of said orthotic parameters;
construct a foot orthotic model comprising data representing an orthotic surface of said foot orthotic device, said orthotic surface constructed based on said selected points with adjusted coordinates; and
provide said foot orthotic model to a fabrication facility over said input/output device for automated fabrication of said foot orthotic device based on said foot orthotic model.

11. The computing device of claim 10, wherein said selected lines comprise three longitudinal lines and three transverse lines.

12. The computing device of claim 10, wherein said code further causes said computing device to:
determine a reference plane, a longitudinal axis, and a transverse axis for said contoured surface, wherein said reference plane is parallel to said longitudinal axis and said transverse axis and is perpendicular to a vertical axis for said contoured surface; and
re-register said plurality of discrete points in a coordinate system such that each one of said longitudinal lines is in a corresponding plane parallel to said longitudinal axis and said vertical axis, and each one of said transverse lines is in a corresponding plane parallel to said transverse axis and said vertical axis.

13. The computing device of claim 12, wherein said each line is determined using a spline function and control points distributed along said corresponding plane.

14. The computing device of claim 13, wherein said code causes said computing device to partition said contour surface into a heel section and a forefoot section, and wherein said reference plane is defined by a bottom point in said heel section, a lateral bottom point in said forefoot section, and a medial bottom point in said forefoot section.

15. The computing device of claim 14, wherein said orthotic parameters comprise an arch shape parameter, a heel cup depth parameter, a forefoot width parameter or a heel width parameter; and wherein vertical coordinates of said selected points in said arch section are adjusted based on said arch shape parameter, said heel section is trimmed or extended based on said heel cup depth parameter, said forefoot section or said heel section is narrowed or widened based on said forefoot width parameter or said heel width parameter.

16. The computing device of claim 10, wherein said code causes said computing device to generate additional surface points for said orthotic surface by extrapolation based on said selected points.

17. The computing device of claim 10, wherein said foot orthotic model further comprises data representing a bottom surface opposite to said orthotic surface, said bottom surface constructed based on a pre-defined surface and a second subset of said orthotic parameters.

18. The computing device of claim 17, wherein said orthotic parameters comprise a posting parameter, and said bottom surface is tilted, or includes a posting for raising said heel or forefoot section, based on said posting parameter.

19. The computing device of claim 10, wherein said computing device is in communication with a scanning device for providing said first data structure and with a user interface device for providing said second data structure, and wherein said fabrication facility comprises an additive manufacturing device for fabricating said foot orthotic device.

20. A computing device for constructing customized foot orthotics, comprising:
an input module for receiving a first data structure comprising three-dimensional coordinates of discrete points on a plantar surface of a scanned foot and a second data structure comprising a plurality of orthotic parameters for constructing foot orthotics customized for the scanned foot;
a contour constructing module configured to determine contour points distributed along selected longitudinal and transverse lines on said plantar surface, and to adjust coordinates of the contour points based on a first subset of said orthotic parameters;
a model constructing module configured to construct an orthotic surface based on said contour points with adjusted coordinates, and to construct a orthotic model based said orthotic surface; and
an output module for communicating with a fabrication device to produce customized foot orthotics from said orthotic model.
